(19) United States
(12) Patent Application Publication
(10) Pub. No.: US 2025/0285177 A1
(43) Pub. Date: Sep. 11, 2025

(54) TRANSACTION CARD TO FACILITATE CLIENT DEVICE AUTHENTICATION AND CONTACTLESS TRANSACTIONS

(71) Applicant: Truist Bank, Charlotte, NC (US)

(72) Inventor: Heather Young, Charlotte, NC (US)

(73) Assignee: Truist Bank, Charlotte, NC (US)

(21) Appl. No.: 18/601,425

(22) Filed: Mar. 11, 2024

(51) Int. Cl. G06Q 40/02; G06F 16/955; G06K 19/06; G06K 19/07

(52) U.S. Cl. CPC G06Q 40/02; G06F 16/9554; G06K 19/06037; G06K 19/0723

(57) ABSTRACT

A transaction card, a computing device, a computer program product, a computer-implemented system, and a computer-implemented method for delivering financial services and, more particularly, facilitating client device authentication via a two-dimensional, machine-readable barcode (e.g., a quick response (QR) code) containing a link to facilitate an automatic launch of a financial institution mobile application and client authentication credentials that facilitates authenticated client device access to one or more client financial accounts maintained by the financial institution.

### TECHNICAL FIELD

The present disclosure relates to a transaction card, a computing device, a computer program product, a computer-implemented system, and a computer-implemented method for delivering financial services and, more particularly, facilitating client device authentication via a two-dimensional, machine-readable barcode (e.g., a quick response (QR) code) containing client authentication credentials that facilitate authenticated client device access to one or more client financial accounts maintained by the financial institution, and a link to facilitate an automatic launch of either a financial institution mobile application or a financial institution web application.

### BACKGROUND

Financial institutions that provide financial services are increasingly providing a greater number of client services. Traditional client services extended by financial institutions required in-person visits by clients. Accordingly, financial institutions focused on in-person client interaction to enhance the quality of services. This simplified model of financial services, while still in use, has been greatly expanded.

Financial institutions now offer digital or online financial services clients, thereby obviating the need for in-person visits to the financial institution. In this way, clients can receive financial services at home via a computing device in order to access and manage one or more client financial accounts, such as online bill payments, money transfers, etc.

While client receipt of digital or online financial services is convenient, financial institutions would like to maintain the same level of safety and quality of service received by clients during in-person visits.

### SUMMARY

One or more embodiments of the present disclosure relate to a transaction card, a computing device, a computer program product, a computer-implemented system, and a computer-implemented method for delivering financial services and, more particularly, facilitating client device authentication via a two-dimensional, machine-readable barcode (e.g., a quick response (QR) code) containing: client authentication credentials that facilitate authenticated client device access to one or more client financial accounts maintained by the financial institution, and a link to facilitate an automatic launch of a financial institution mobile application or a financial institution web application. One or more financial institution servers are operable to capture and populate the client authentication credentials into one or more client authentication fields to enhance the efficiency of mobile transactions. In so doing, a client device is granted authenticated access to a financial institution mobile application to thereby facilitate client management of one or more client financial accounts maintained by the financial institution on behalf of the client.

In accordance with one or more embodiments set forth, illustrated, and described herein, a transaction card comprises one or more of the following: a substrate that includes: a first (e.g., front) surface having displayed or embedded thereon a first machine-readable component (e.g. a smart chip) that facilitates a contactless financial transaction, and a second (e.g., rear) surface, opposite the first surface, having displayed or embedded thereon a second machine-readable component (e.g., two-dimensional barcode, a quick response (QR) code) containing client authentication credentials that facilitate authenticated client device access to one or more client financial accounts maintained by the financial institution, and a link to facilitate an automatic launch of either a financial institution mobile application or a financial institution web application.

In accordance with one or more embodiments set forth, illustrated, and described herein, a transaction card comprises one or more of the following: a substrate that includes: a first surface having displayed or embedded thereon a first machine-readable component that facilitates a contactless financial transaction, and a second surface, opposite the first surface, having displayed or embedded thereon a second machine-readable component containing a link to facilitate an automatic launch of the financial institution mobile application or the financial institution web application (and thereby facilitate a visual display of an client authentication dashboard having authentication credential fields on a user interface of a client device). Through the authentication dashboard, authenticated client device access to one or more client financial accounts maintained by the financial institution may be gained. In that way, a client can perform one or more tasks related to the one or more client financial accounts.

In accordance with the transaction card, the substrate has an irregular geometric shape or cross-section.

In accordance with the transaction card, the substrate has a shape that is asymmetric along at least one axis (e.g., longitudinal axis).

In accordance with the transaction card, the substrate has a shape that is asymmetric along a longitudinal axis thereof.

In accordance with the transaction card, the substrate has a shape that is asymmetric along a transverse axis thereof.

In accordance with the transaction card, the substrate has an irregular polygonal shape.

In accordance with the transaction card, the irregular polygonal shape comprises an irregular hexagon.

In accordance with the transaction card, the irregular hexagon is defined by, in sequence: a first upper segment of a first length, a second upper segment of a second length, a third upper segment of a third length, a first lateral segment of a fourth length, a lower segment of a fifth length, and a third lateral segment of a sixth length.

In accordance with the transaction card, the second upper segment extends between the first upper segment and the third upper segment at an angle greater than 180 degrees.

In accordance with the transaction card, the first length is less than the third length. Alternatively, the first length is greater than the second length.

In accordance with the transaction card, the first upper segment extends in a first plane and the third upper segment extends in a second plane that is parallel to the first plane.

In accordance with the transaction card, the substrate further includes a keychain aperture extending from the first surface to the second surface to facilitate connection of the transaction card on a keychain.

In accordance with the transaction card, the first machine-readable component comprises a smart chip.

In accordance with the transaction card, the first machine-readable component comprises an integrated circuit chip.

In accordance with the transaction card, the second machine-readable component comprises a two-dimensional, machine-readable barcode.

In accordance with the transaction card, the two-dimensional, machine-readable barcode comprises a quick response (QR) code.

In accordance with the transaction card, the client authentication credentials contained in the second machine-readable component facilitates automatic population of authentication credential fields with captured client authentication credentials.

In accordance with the transaction card, the second machine-readable component facilitates, in response to a capture of the client authentication credentials by a computing device, an automatic launching of a financial institution mobile application or a financial institution web application on the computing device.

In accordance with the transaction card, the second machine-readable component facilitates, in response to a capture of the client authentication credentials by a computing device, an automatic population of client device authentication fields with the captured client authentication credentials on a user interface of the computing device.

In accordance with the transaction card, the second machine-readable component facilitates, in response to a capture of the client authentication credentials by a computing device, automatic transmission of a command to a second computing device to accept the authentication credentials.

In accordance with the transaction card, the transaction card comprises a financial transaction card that facilitates contactless financial transactions.

In accordance with one or more embodiments set forth, illustrated, and described herein, a computer-implemented system comprises one or more of the following: one or more processors; and a non-transitory memory coupled to the one or more processors, the non-transitory memory including a set of instructions, which when executed by the one or more processors, cause a computing device to: capture, from a machine-readable component displayed on a transaction card, client authentication credentials and a link to facilitate an automatic launch of a financial institution mobile application or a financial institution web application; and causing, on a user interface of the computing device in response to capturing the link, an automatic launch of the financial institution mobile application or the financial institution web application on the computing device.

In accordance with one or more embodiments set forth, illustrated, and described herein, a computer-implemented system comprises one or more of the following: one or more processors; and a non-transitory memory coupled to the one or more processors, the non-transitory memory including a set of instructions, which when executed by the one or more processors, cause a computing device to: capture, from a machine-readable component displayed on a transaction card, client authentication credentials and a link to facilitate an automatic launch of a financial institution mobile application or a financial institution web application; and cause, on a user interface of the computing device in response to capturing the link, an automatic launch of the financial institution mobile application or the financial institution web application on the computing device.

In accordance with one or more embodiments set forth, illustrated, and described herein, a computer-implemented system comprises one or more of the following: one or more processors; and a non-transitory memory coupled to the one or more processors, the non-transitory memory including a set of instructions, which when executed by the one or more processors, cause a computing device to: capture, from two-dimensional, machine-readable barcode displayed on a transaction card, client authentication credentials and a link to facilitate an automatic launch of a financial institution mobile application or a financial institution web application; decode the two-dimensional, machine-readable barcode; and cause, on a user interface of the computing device in response to decoding the two-dimensional, machine-readable barcode, an automatic launch of the financial institution mobile application or the financial institution web application on the computing device.

In accordance with the computer-implemented system, the machine-readable component comprises a two-dimensional, machine-readable barcode.

In accordance with the computer-implemented system, the two-dimensional, machine-readable barcode comprises a quick response (QR) code.

In accordance with the computer-implemented system, the non-transitory memory including a set of instructions, which when executed by the one or more processors, cause the computing device to decode, in response to capturing the client authentication credentials and temporally before causing the automatic launch of the financial institution mobile application, the two-dimensional, machine-readable barcode.

In accordance with the computer-implemented system, causing the automatic launch of the financial institution mobile application comprises causing a visual display of a client device authentication dashboard associated with the financial institution mobile application.

In accordance with the computer-implemented system, the client device authentication dashboard includes a plurality of client device authentication fields.

In accordance with the computer-implemented system, the non-transitory memory including a set of instructions, which when executed by the one or more processors, cause the computing device to cause, in response to capturing the client authentication credentials, automatic population of the client device authentication fields with the captured client authentication credentials.

In accordance with the computer-implemented system, the non-transitory memory including a set of instructions, which when executed by the one or more processors, cause the computing device to cause, in response to the automatic population of the client device authentication fields, transmission of a command to a second computing device to accept the authentication credentials.

In accordance with one or more embodiments set forth, illustrated, and described herein, a computer-implemented method comprises one or more of the following: capturing, by a computing device from a machine-readable component displayed on a transaction card, client authentication credentials and a link to facilitate an automatic launch of a financial institution mobile application or a financial institution web application; and causing, by the computing device on a user interface of the first computing device in response to capturing the link, an automatic launch of the financial institution mobile application or the financial institution web application on the computing device.

In accordance with one or more embodiments set forth, illustrated, and described herein, a computer-implemented method comprises one or more of the following: capturing, by a computing device from a machine-readable component displayed on a transaction card, client authentication credentials and a link to facilitate an automatic launch of a financial institution mobile application or a financial institution web application; and causing, by the computing device on a user interface of the computing device in response to capturing the link, an automatic launch of a financial institution mobile application or the financial institution web application on the computing device.

In accordance with one or more embodiments set forth, illustrated, and described herein, a computer-implemented method comprises one or more of the following: capturing, by a computing device from two-dimensional, machine-readable barcode displayed on a transaction card, client authentication credentials and a link to facilitate an automatic launch of a financial institution mobile application or a financial institution web application; decoding, by the computing device, the two-dimensional, machine-readable barcode; and causing, by the computing device on a user interface of the computing device in response to decoding the two-dimensional, machine-readable barcode, an automatic launch of the financial institution mobile application or the financial institution web application on the computing device.

In accordance with the computer-implemented method, the machine-readable component comprises a two-dimensional, machine-readable barcode.

In accordance with the computer-implemented method, the two-dimensional, machine-readable barcode comprises a quick response (QR) code.

In accordance with the computer-implemented method, further comprising decoding, by the computing device in response to capturing the client authentication credentials and temporally before causing the automatic launch of the financial institution mobile application, the two-dimensional, machine-readable barcode.

In accordance with the computer-implemented method, causing the automatic launch of the financial institution mobile application comprises causing a visual display of a client device authentication dashboard associated with the financial institution mobile application.

In accordance with the computer-implemented method, the client device authentication dashboard includes a plurality of client device authentication fields.

In accordance with the computer-implemented method, further comprising causing, by the computing device in response to capturing the client authentication credentials, automatic population of the client device authentication fields with the captured client authentication credentials.

In accordance with the computer-implemented method, further comprising causing, by the computing device in response to the automatic population of the client device authentication fields, transmission of a command to a second computing device to accept the authentication credentials.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the mobile device of FIG. 1.

FIG. 3 illustrates a block diagram of the personal computing device of FIG. 1.

FIG. 4 illustrates a block diagram of the one or more financial institution servers of FIG. 1.

FIGS. 5A and 5B respectively illustrate front surface and a rear surface of a transaction card, in accordance with one or more embodiments set forth and described herein.

FIG. 6 illustrates a dashboard that includes a client device having a user interface with a dashboard visually displayed thereon, in accordance with one or more embodiments set forth and described herein.

FIG. 7 illustrates a user interface having a client device authentication dashboard visually displayed thereon, in accordance with one or more embodiments set forth and described herein.

FIG. 8 illustrates a method of fabricating a transaction card, in accordance with one or more embodiments set forth and described herein.

FIGS. 9 through 11 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user or client, including personal computers, laptops, tablets, and/or mobile smartphones.

As used herein, “modules” or engines relates to either software modules or engines (e.g., code embodied on a machine-readable medium or in a transmission signal) or hardware modules. Certain embodiments are described herein as including logic or a number of components, modules, or mechanisms. A “hardware module” or “hardware engine” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules or engines of a computer system (e.g., a processor or a group of processors) may be configured by software (e.g., an application or application portion) as a hardware module or engine that operates to perform certain operations as described herein. In some embodiments, a hardware module or engine may be implemented mechanically, electronically, or any suitable combination thereof. For example, a hardware module or engine may include dedicated circuitry or logic that is permanently configured to perform certain operations. For example, a hardware module or engine may be a special-purpose processor, such as an FPGA or an ASIC. A hardware module or engine may also include programmable logic or circuitry that is temporarily configured by software to perform certain operations. A hardware module or engine may include software encompassed within a general-purpose processor or other programmable processor. It will be appreciated that the decision to implement a hardware module or engine mechanically, in dedicated and permanently configured circuitry, or in temporarily configured circuitry (e.g., configured by software) may be driven by cost and time considerations. Accordingly, the phrase “hardware module or engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module or engine” refers to a hardware module or engine. Considering embodiments in which hardware modules or engines are temporarily configured (e.g., programmed), each of the hardware modules or engines need not be configured or instantiated at any one instance in time. For example, where a hardware module or engine comprises a general-purpose processor configured by software to become a special-purpose processor, the general-purpose processor may be configured as respectively different special-purpose processors (e.g., comprising different hardware modules or engines) at different times. Software may accordingly configure a processor, for example, to constitute a particular hardware module or engine at one instance of time and to constitute a different hardware module or engine at a different instance of time. Hardware modules or engines can provide information to, and receive information from, other hardware modules or engines. Accordingly, the described hardware modules or engines may be regarded as being communicatively coupled. Where multiple hardware modules or engines exist contemporaneously, communications may be achieved through signal transmission (e.g., over appropriate circuits and buses) between or among two or more of the hardware modules or engines. In embodiments in which multiple hardware modules or engines are configured or instantiated at different times, communications between such hardware modules or engines may be achieved, for example, through the storage and retrieval of information in memory structures to which the multiple hardware modules or engines have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” or “processor-Implemented engine” relates to a hardware module or engine implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules or engines that operate to perform one or more operations or functions described herein.

As used herein, “server” relates to a server computer or group of computers that acts to provide a service for a certain function or access to a network resource. A server may be a physical server, a hosted server in a virtual environment, or software code running or executing on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, engine, or system senses as sufficiently immediate for a particular process or determination to be made, or that enables the processor to keep up with some external process.

As used herein, “user” or “client” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within a financial application.

As used herein, “irregular geometric shape” relates to a geometric shape having sides of different or unequal lengths and interior angles of different or unequal measure.

A communication environment that facilitates enhanced client communication with a financial institution in support of client device access and client management of one or more client financial accounts maintained by the financial institution. Upon the automatic launching of a dashboard of the financial institution on a client device, a client may transmit data related to the client financial account(s), and also receive data and information pertaining to such client financial account(s). Such data may be encrypted during communications between the client device and the one or more financial servers.

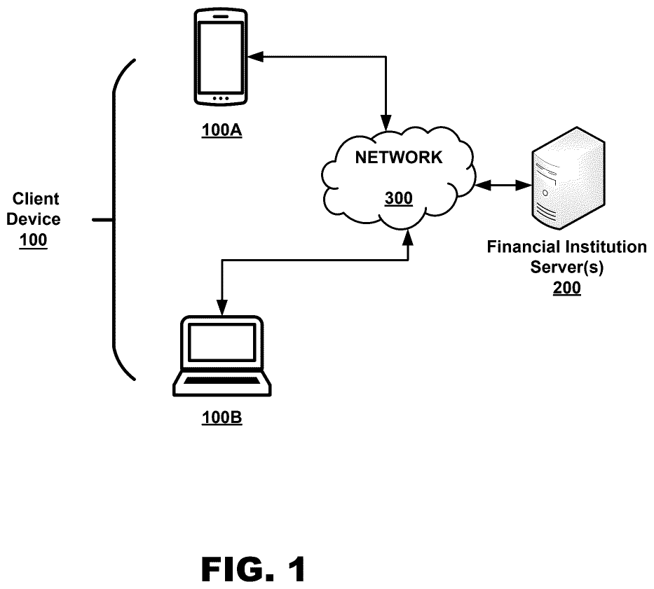

Turning to the figures, in which FIG. 1 illustrates a communication environment in which a client communicates with a financial institution. A client or client device 100 operating in the communication environment facilitates client device access to and client management of one or more client financial accounts residing at one or more financial institution servers 200 of the financial institution. The communication environment includes the client device 100, the one or more financial institution servers 200, and a communications network 300 through which communication is facilitated between the client device 100 and the one or more financial institution servers 200.

In accordance with one or more embodiments set forth, described, and/or illustrated herein, the client or client device 100 comprises a computing device, including but not limited to a smart phone (e.g., 100A), personal computing device (e.g., 100B), a laptop computer, a handheld personal computer, a workstation, a game console, a cellular phone, a mobile device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

In accordance with one or more embodiments set forth, described, and/or illustrated herein, each server in the one or more financial institution servers 200 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

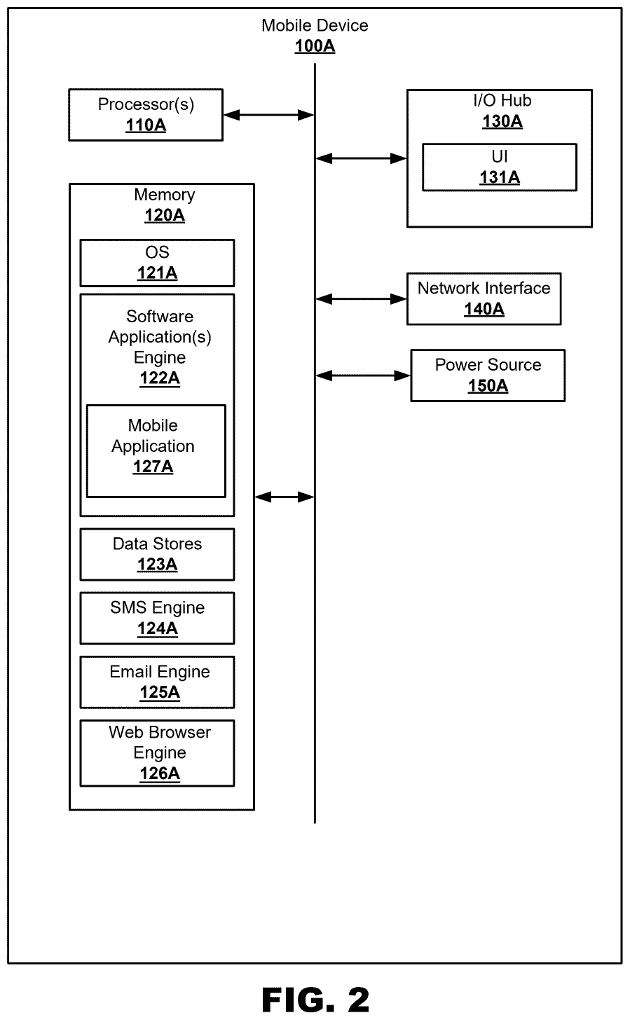

In the illustrated example embodiment of FIG. 2, the client device 100 comprises a mobile device 100A. Some of the possible operational elements of the mobile device 100A are illustrated in FIG. 2 and will now be described herein. It will be understood that it is not necessary for the mobile device 100A to have all the elements illustrated in FIG. 2. For example, the mobile device 100A may have any combination of the various elements illustrated in FIG. 2. Moreover, the mobile device 100A may have additional elements to those illustrated in FIG. 2.

The mobile device 100A includes one or more processors 110A, a non-transitory memory 120A operatively coupled to the one or more processors 110A, an I/O hub 130A, a network interface 140A, and a power source 150A.

The memory 120A comprises a set of instructions of computer-executable program code. The set of instructions are executable by the one or more processors 110A to cause execution of an operating system 121A and one or more software applications of a software application engine 122A that reside in the memory 120A. The one or more software applications residing in the memory 120A includes, but is not limited to, a financial institution application that is associated with the financial institution. The financial institution application comprises a mobile application 127A that facilitates establishment of a secure connection between the mobile device 100A and the one or more financial institution servers 200. The one or more processors 110A are operable to execute the mobile application to facilitate client device access to the client financial account(s) for client management of the client financial accounts.

The memory 120A also includes one or more data stores 123A that are operable to store one or more types of data. The mobile device 100A may include one or more interfaces that facilitate one or more systems or modules or engines thereof to transform, manage, retrieve, modify, add, or delete, the data residing in the data stores 123A. The one or more data stores 123A may comprise volatile and/or non-volatile memory. Examples of suitable data stores 123A include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123A may be a component of the one or more processors 110A, or alternatively, may be operatively connected to the one or more processors 110A for use thereby. As set forth, described, and/or illustrated herein, “operatively connected” may include direct or indirect connections, including connections without direct physical contact.

The memory 120a also includes an SMS engine 124A operable to facilitate client transmission and receipt of text messages via the mobile device 100A though the network 300. In one example embodiment, a client may receive text messages from the financial institution that are associated with the client device access for client management of the client financial account(s). An email engine 125A is operable to facilitate client transmission and receipt of email messages via the mobile device 100A through the network 300. In one example embodiment, a client may receive email messages from the financial institution that are associated with the client device access for client management of the client financial account(s). A client may utilize a web browser engine 126A that is operable to facilitate client device access to one or more websites associated with the financial institution through the network 300.

In accordance with one or more embodiments set forth, described, and/or illustrated herein, the mobile device 100A includes an I/O hub 130A operatively connected to other systems and subsystems of the mobile device 100A. The I/O system 130A may include one or more of an input interface, an output interface, and a network controller to facilitate communications between the client device 100 and the server 200. The input interface and the output interface may be integrated as a single, unitary user interface 131A, or alternatively, be separate as independent interfaces that are operatively connected.

As used herein, the input interface is defined as any device, software, component, system, element, or arrangement or groups thereof that enable information and/or data to be entered as input commands by a client in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a client. The output interface may comprise one or more of a visual display or an audio display, including, but not limited to, a microphone, earphone, and/or speaker. One or more components of the mobile device 100A may serve as both a component of the input interface and a component of the output interface.

The mobile device 100A includes a network interface 140A operable to facilitate connection to the network 300. The mobile device 100A also includes power source 150A that comprises a wired powered source, a wireless power source, a replaceable battery source, or a rechargeable battery source.

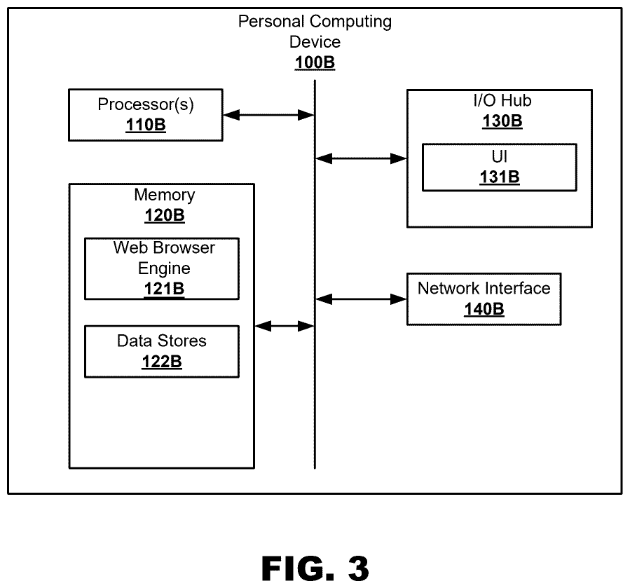

In the illustrated example embodiment of FIG. 3, the client device 100 comprises personal computing device 100B. Some of the possible operational elements of the personal computing device 100B are illustrated in FIG. 3 and will now be described herein. It will be understood that it is not necessary for the personal computing device 100B to have all the elements illustrated in FIG. 3. For example, the personal computing device 100B may have any combination of the various elements illustrated in FIG. 3. Moreover, the personal computing device 100B may have additional elements to those illustrated in FIG. 3.

The personal computing device 100B includes one or more processors 110B, a non-transitory memory 120B operatively coupled to the one or more processors 110B, an I/O hub 130B, and a network interface 140B.

The memory 120B comprises a set of instructions of computer-executable program code. The set of instructions are executable by the one or more processors 110B to cause control of the web browser engine 121B in a manner that facilitates client device access to a web browser having one or more websites associated with the financial institution through the network 300.

The memory 120B also includes one or more data stores 122B that are operable to store one or more types of data. The personal computing device 100B may include one or more interfaces that facilitate one or more systems or modules or engines thereof to transform, manage, retrieve, modify, add, or delete, the data residing in the data stores 122B. The one or more data stores 122B may comprise volatile and/or non-volatile memory. Examples of suitable data stores 122B include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122B may be a component of the one or more processors 110B, or alternatively, may be operatively connected to the one or more processors 110B for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110A, 110B may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110A, 110B may comprise at least one hardware circuit (e.g., an integrated circuit) operable to carry out instructions contained in program code. In embodiments in which there is a plurality of processors, such processors may work independently from each other, or one or more processors may work in combination with each other.

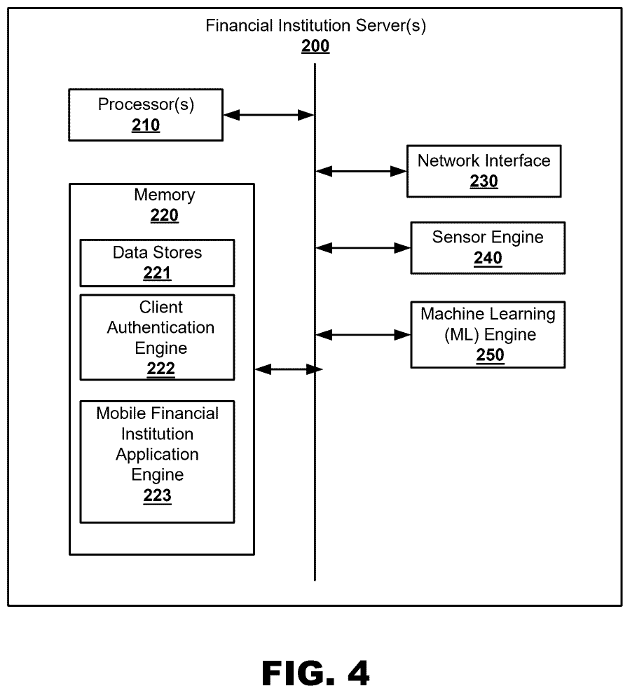

As illustrated in FIG. 4, the one or more financial institution servers 200 includes one or more processors 210, a non-transitory memory 220 operatively coupled to the one or more processors 210, a network interface 230, a sensor engine 240, and a machine learning (ML) engine 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a client authentication engine 222 and a financial institution mobile application engine 223 having one or more financial institution mobile applications that reside in the memory 220. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, client account data, client authentication data, sensor data, etc. For instance, the one or more data stores 221 may comprise a storage location on which resides one or more electronic files of data and information associated with wireless network connectivity data, stored geographic location data, and sensor data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the server(s) to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to execute certain logic, data-processing, and data-storing functions of the one or more financial institution servers 200, in addition to certain communication functions of the one or more financial institution servers 200. The one or more financial institution mobile application s of the financial institution mobile application engine 223 are operable to communicate with the client device 100 in a manner which facilitates client device access to the client financial account(s) for client management of the client financial account(s) based on successful client device authentication. The data exchanged between the client device 100 and the one or more financial servers 200 may be encrypted during communications therebetween.

The sensor engine 240 is operable, at least during execution of the mobile application by the client device 100, to dynamically detect, determine, assess, monitor, measure, quantify, and/or sense information about the client device 100. The sensor engine 240 may be operable to detect, determine, assess, monitor, measure, quantify and/or sense in real-time. The sensor engine 240 may be operable to detect, determine, assess, monitor, measure, quantify, and/or sense geographic location information about the geographic location of the client device 100.

The ML engine 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML engine 250 may analyze the received data and/or information, and transform the data and/or information in a manner which provides enhanced communication between the client device 100 and the one or more financial institution servers 200, while also enhancing client device access for client management of the client financial accounts. The data and/or information may also be up-linked to other systems, engines, and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a client may, via the mobile device 100A, execute a mobile application associated with the financial institution over the communication network 300. The computer-executable program code may instruct the one or more processors 210 to cause, via the client authentication engine 222, generation of a client authentication dashboard 700 for visual display on the UI 131A of the mobile device 100A to gain client device access to the one or more client financial accounts maintained by the financial institution. The client authentication dashboard 700 includes financial account content associated with the client financial accounts. The client authentication dashboard 700 also includes one or more client device authentication fields 702 that include, but are not limited to, user identity (e.g., username), a user passcode, a cookie, user biometric data, a private key, a token, and/or another suitable authentication data or information. To issue a command to the one or more financial institution servers 200 to accept the authentication credentials, the client may engage a user-engageable log in tile 704. The client authentication dashboard 700 may also include a QR code tile 706 having a user engageable arrowhead that allows the client to use a QR code containing client authentical credentials that may be automatically populated into the client device authentication fields 702.

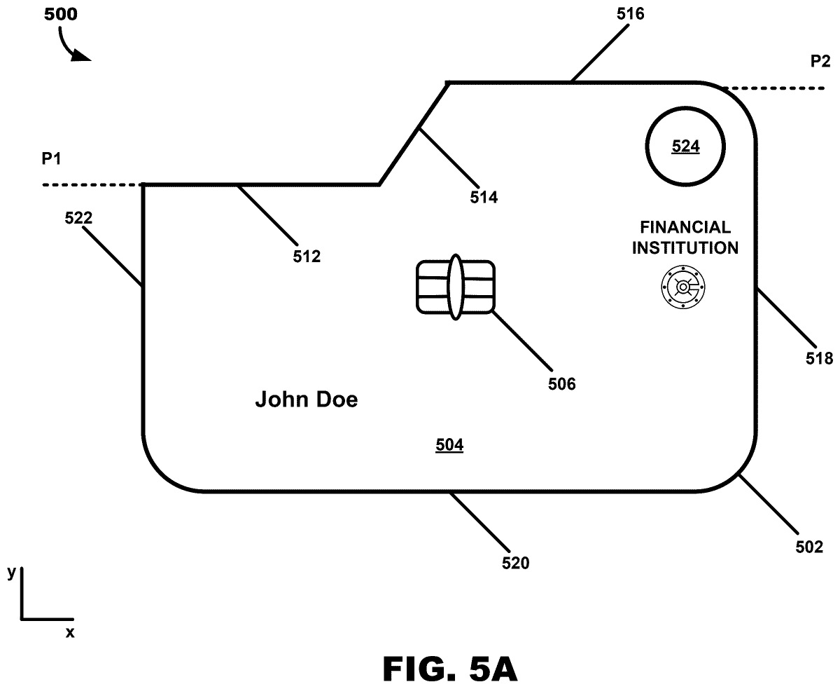

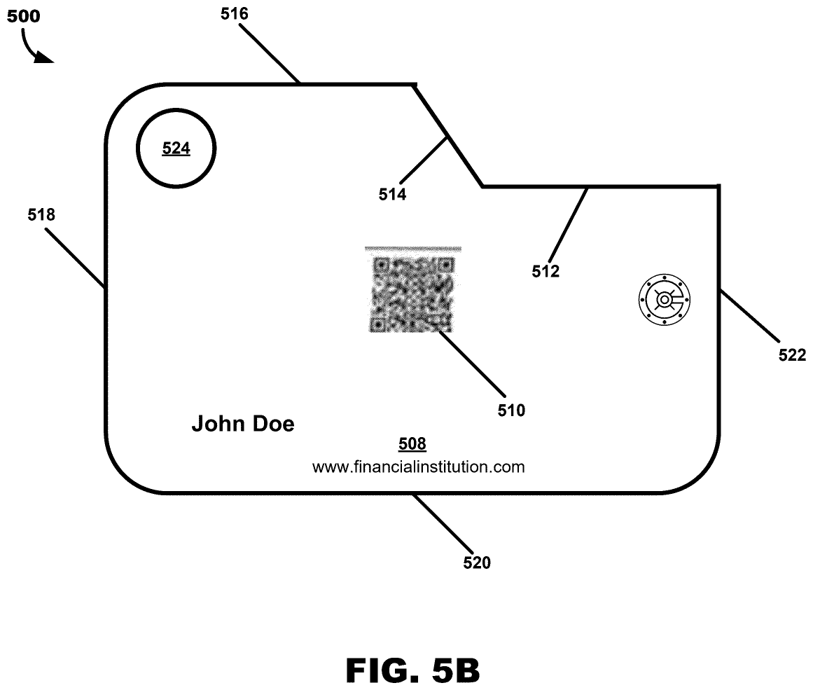

FIGS. 5A and 5B respectively illustrate a transaction card 500 issued by the financial institution to a client. The transaction card 500 includes one or more first machine-readable components that facilitate several features with respect to the one or more financial accounts maintained by the financial institution on behalf of the client. The transaction card 500 is formed as a substrate 502 having a first or front surface 504 (FIG. 5A) and a second or rear surface 508 (FIG. 5B) opposite the front surface 504. The substrate 502 includes one or more tactile structural features defining a stepped configuration that imparts a reduced overall size to the transaction card 500 to enhance ergonomic gripping by the client. In one example embodiment, the substrate 502 has an irregular geometric shape or cross-section. Alternatively or additionally, the substrate 502 has an asymmetric shape along at least one axis, such as, for example, a central longitudinal axis (x-axis) or a central transverse axis (y-axis).

Alternatively or additionally, the substrate 502 has an irregular polygonal shape such as, for example, an irregular hexagon. In the illustrated embodiment, the irregular hexagon is defined by, in sequence in a clockwise direction, a first upper segment 512 of a first length, a second upper segment 514 of a second length, a third upper segment 516 of a third length, a first lateral segment 518 of a fourth length, a lower segment 520 of a fifth length, and a third lateral segment 522 of a sixth length. In one example embodiment, the first length is less than the third length. Alternatively, the first length is greater than the second length. Alternatively, the first length is equal to the second length.

The second upper segment 514 extends between the first upper segment 512 and the third upper segment 516 at an angle greater than 180 degrees, and thus, defines a stepped feature. The first upper segment 512 extends in a first plane P1, while the third upper segment 516 extends in a second plane P1 that is offset a distance from (from the y-axis) and parallel to the first plane P1.

The substrate 502 further includes a keychain aperture 524 that extends from the front surface 504 to the rear surface 508 to facilitate connection of the transaction card 500 to a keychain.

A first machine-readable component 506, such as, for example, a smart chip (e.g., an integrated circuit chip) is displayed, arranged, or otherwise embedded on the front surface 504 to facilitate contactless financial transactions associated with one of the one or more financial accounts of the client. In contrast to traditional transaction cards, the front surface 504 and the rear surface 508 of the substrate 502 does not include any visible indicia regarding a distinctive transaction card number that is associated with one of the one or more client financial accounts. Neither the front surface 504 nor the rear surface 508 of the substrate 502 include a magnetic strip. In this way, the only type of financial transactions that may be performed by the transaction card 500 are contactless.

A second machine-readable component, such as, for example, a distinctive (e.g., unique to the client and/or the transaction card 500), two-dimensional machine-readable barcode 510 containing data and information associated with the financial institution and/or one of the one or more financial accounts of the client. The distinctive two-dimensional, machine-readable barcode 510 may comprise, for example, a quick response (QR) code. The QR code contains, but is not limited to, client data and information such as, for example, client authentication credentials that facilitate authenticated client device access to the financial institution mobile application (and thus, the one or more client financial accounts maintained by the financial institution). This disclosure contemplates the QR code containing any client data and information that optimizes or otherwise transforms the performance and functionality of the one or more embodiments in a manner that falls within the spirit and scope of the principles of this disclosure. For example, the client data and information can include client PII (e.g., client name, client address, client phone number, etc.) and client financial data and information.

### Client Device Authentication Protocol 1

In accordance with one example embodiment, a general client device authentication may involve, by the client via the mobile device 100A after launching a financial institution mobile application or a financial institution web application, manual population of client authentication credentials into the one or more client device authentication fields 702 of the client device authentication dashboard 700. Having populated the client authentication credentials into the one or more client device authentication fields 702, the client may then engage the user-engageable log in tile 704, which in turn causes a transmission of a command to the one or more financial institution servers 200 to accept the authentication credentials.

### Client Device Authentication Protocol 2

In accordance with another example embodiment, in response to launching a financial institution mobile application or a financial institution web application by the mobile device 100A (to thereby cause a visual display of the client device authentication dashboard 700 on the UI 131A of the mobile device 100A), a client may bypass manual population of client authentication credentials (via the general client device authentication noted hereinabove) using the following protocol.

The client may scan, using a reader (e.g., a camera application) of the mobile device 100A, the distinctive, two-dimensional machine-readable barcode 510 displayed on the rear surface 508 of the substrate 502. The set of instructions, which when executed by the one or more processors 110A, may cause the mobile device 100A to decode the distinctive, two-dimensional machine-readable barcode 510. The set of instructions, which when executed by the one or more processors 110A, may cause the mobile device 100A to capture the client authentication credentials from the decoded distinctive, two-dimensional machine-readable barcode 510 and then automatically populate the client device authentication fields 702 with the captured client authentication credentials. Now that the client authentication credentials are auto-populated into the one or more client device authentication fields 702, the client may then engage the user-engageable log in tile 704 to cause a transmission of a command to the one or more financial institution servers 200 to accept the authentication credentials.

Should the client authentication credentials be acceptable, the computer-executable program code may instruct the one or more processors 210 of the one or more financial institution servers 200 to cause generation of the dashboard 600 for visual display on the UI 131A of the mobile device 100A.

Thus, using the distinctive, two-dimensional machine-readable barcode 510 displayed on the transaction card 500, a client can quickly and efficiently gain client device access to the one or more client financial accounts maintained by the financial institution.

### Client Device Authentication Protocol 3

In accordance with a further example embodiment, the client may scan, using a reader (e.g., a camera application) of the mobile device 100A, the distinctive, two-dimensional machine-readable barcode 510 displayed on the rear surface 508 of the substrate 502, the distinctive, two-dimensional machine-readable barcode 510 containing client authentication credentials and a link to facilitate an automatic launch of a financial institution mobile application. The set of instructions, which when executed by the one or more processors 110A, may cause the mobile device 100A to decode the distinctive, two-dimensional machine-readable barcode 510. The set of instructions, which when executed by the one or more processors 110A, may cause the mobile device 100A to capture client authentication credentials and the link to facilitate an automatic launch of the financial institution mobile application.

Responsive to capturing the client authentication credentials and the link to facilitate the automatic launch of the financial institution mobile application, the set of instructions, which when executed by the one or more processors 110A, may cause the mobile device 100A to cause automatic launching of the financial institution mobile application, a visual display of the client device authentication dashboard 700, and automatic population of the client device authentication fields 702 with the captured client authentication credentials. All such actions may be executed contemporaneously or sequentially. All such actions may be executed contemporaneously or sequentially.

The client may then engage the user-engageable log in tile 704 to cause transmission of a command to the one or more financial institution servers 200 to accept the authentication credentials. Should the client authentication credentials be acceptable, the computer-executable program code may instruct the one or more processors 210 of the one or more financial institution servers 200 to cause generation of the dashboard 600 for visual display on the UI 131A of the mobile device 100A.

Thus, using the distinctive, two-dimensional machine-readable barcode 510 displayed on the transaction card 500, a client can quickly and efficiently gain client device access to the one or more client financial accounts maintained by the financial institution.

### Client Device Authentication Protocol 4

In accordance with yet another example embodiment, the client may scan, using a reader (e.g., a camera application) of the mobile device 100A, the distinctive, two-dimensional machine-readable barcode 510 displayed on the rear surface 508 of the substrate 502, the distinctive, two-dimensional machine-readable barcode 510 containing client authentication credentials and a link to facilitate an automatic launch of a financial institution mobile application. The set of instructions, which when executed by the one or more processors 110A, may cause the mobile device 100A to decode the distinctive, two-dimensional machine-readable barcode 510. The set of instructions, which when executed by the one or more processors 110A, may cause the mobile device 100A to capture client authentication credentials and the link to facilitate an automatic launch of the financial institution mobile application.

Responsive to capturing the client authentication credentials and the link to facilitate an automatic launch of the financial institution mobile application, the set of instructions, which when executed by the one or more processors 110A, may cause the mobile device 100A to cause: automatic launching of the financial institution mobile application or the financial institution web application, a visual display of the client device authentication dashboard 700, automatic population of the client device authentication fields 702 with the captured client authentication credentials, and automatic transmission of a command to the one or more financial institution servers 200 to accept the authentication credentials. All such actions may be executed contemporaneously or sequentially.

Should the client authentication credentials be acceptable, the computer-executable program code may instruct the one or more processors 210 of the one or more financial institution servers 200 to cause generation of the dashboard 600 for visual display on the UI 131A of the mobile device 100A.

Thus, using the distinctive, two-dimensional machine-readable barcode 510 displayed on the transaction card 500, a client can quickly and efficiently (without having to engage the user-engageable log in tile 704) gain client device authentication to the one or more client financial accounts maintained by the financial institution. In essence, contactless (e.g., without physical contact or engagement) client device authentication is achieved.

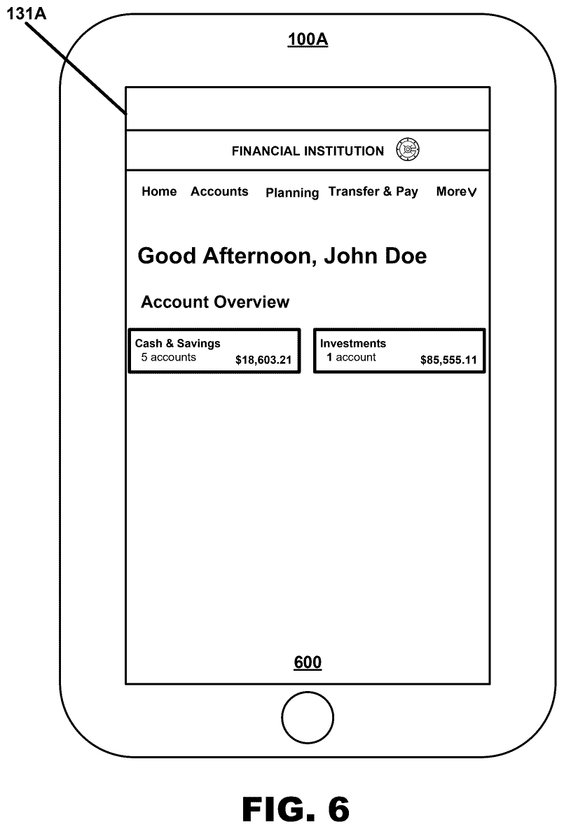

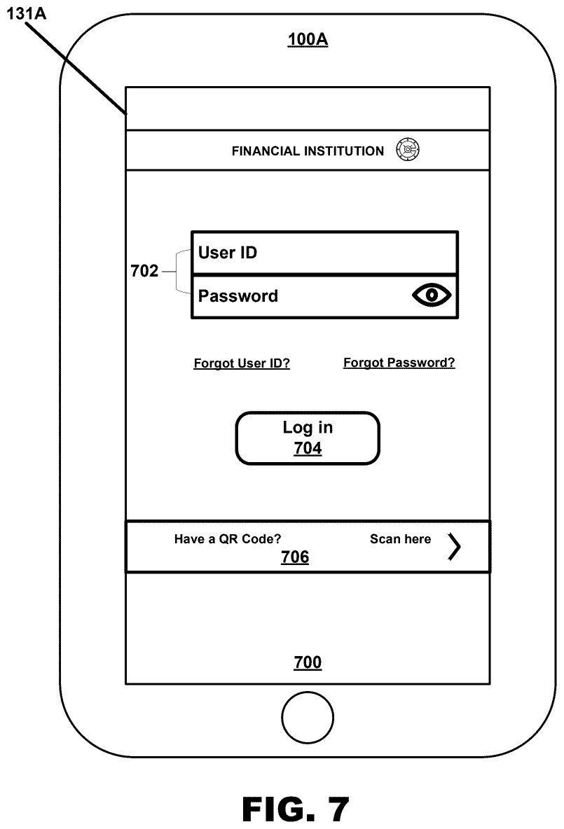

As illustrated in FIG. 6, should the client authentication credentials be acceptable (using any client device authentication protocol), the computer-executable program code may instruct the one or more processors 210 of the one or more financial institution servers 200 to cause generation of a dashboard 600 for visual display on the UI 131A of the mobile device 100A. The dashboard 600 includes a plurality of client information and data associated with the one or more client financial accounts. The dashboard 600 may include a plurality of user-engageable toggles, tiles, switches, tabs, icons, etc. The client, via the mobile device 100A, may then manage the one or more client financial accounts maintained by the financial institution on behalf of the client. Such management may include, but is not limited to, performing financial transactions, transmitting service requests or queries pertaining to one or more financial services (e.g., personal financial services, commercial financial services, and wealth management financial services, etc.), etc.

Responsive to the grant of authenticated client device access to the mobile device 100A, the computer-executable program code may also instruct the one or more processors 210 to cause a generation of an electronic notification (e.g., pop-up, email, text message, etc.) for visual display on the UI 131A of the mobile device 100A. The electronic notification provides a general request for client authorization to detect the current geographic location of the mobile device 100A. Responsive to receipt of authorization by the client via the mobile device 100A, the computer-executable program code may instruct the one or more processors 210 to cause, via the sensor engine 240, detection of the current geographic location of the mobile device 100A. Alternatively, this disclosure contemplates the request or query to authorize the detection of the current geographic location of the mobile device 100A occurring temporally before client device authentication is granted.

The computer-executable program code may instruct the one or more processors 210 to cause dynamic geographic location analysis of wireless network connectivity data, stored geographic location data residing in the memory 220, and sensor data relating to the detected current geographic location of the mobile device 100A. The wireless network connectivity data may include but is not limited to, an internet protocol (IP) address of the mobile device 100A, network identifier for the network 300, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs, etc. The sensor data may include but is not limited to, global positioning system (GPS) data of the mobile device 100A. This disclosure contemplates conducting the geographic location analysis based on any data indicative of a geographic location of the mobile device 100A and which optimizes or otherwise transforms the performance and functionality of the one or more embodiments in a manner that falls within the spirit and scope of the principles of this disclosure.

The system and computer-implemented method(s) described herein may be at least partially processor-implemented, the processors 110A, 110B, 210 being an example of hardware. For example, at least some of the operations of a method may be performed by one or more processors or processor-implemented modules or engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a plurality of machines. In some example embodiments, the one or more processors or processor-implemented modules or engines may be located in a single geographic location (e.g., within a home environment, an office environment, or a server farm). In other example embodiments, the one or more processors or processor-implemented modules or engines may be distributed across a plurality of geographic locations.

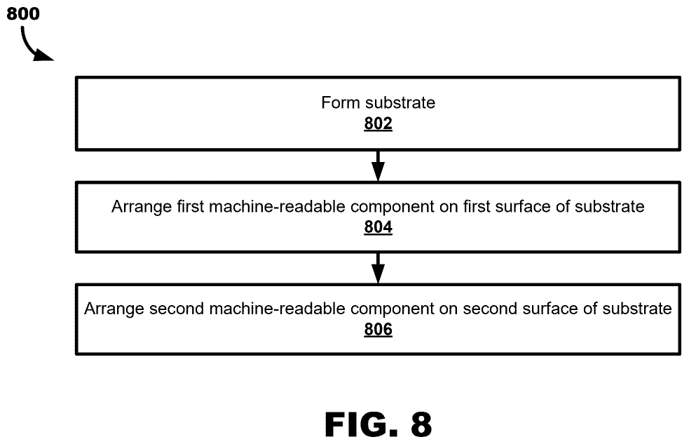

FIG. 8 sets forth a method of fabricating a transaction card, such as, for example, a financial transaction card that facilitates contactless financial transactions. In one or more examples, the flowchart of the method 800 may be implemented by one or more computing devices. In particular, the method 800 may be implemented as one or more modules or engines in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

As illustrated in FIG. 8, illustrated process block 802 of method 800 includes forming a substrate.

In accordance with process block 802, forming the substrate comprises forming the substrate to have an irregular polygonal shape.

In accordance with process block 802, forming the substrate comprises forming the substrate to be asymmetric along at least one axis.

The computer-implemented method 800 may then proceed to illustrated process block 804, which includes arranging, on a first surface of the substrate, a first machine-readable component to facilitate contactless financial transactions.

In accordance with process block 804, the first machine-readable component comprises a smart chip.

The computer-implemented method 800 may then proceed to illustrated process block 806, which includes arranging, on a second surface of the substrate opposite the first surface, a second machine-readable component which contains client authentication credentials and a link to facilitate an automatic launch of a financial institution mobile application or a financial institution web application.

In accordance with process block 806, the second machine-readable component comprises a two-dimensional, machine-readable barcode.

In accordance with process block 806, the two-dimensional, machine-readable barcode comprises a quick response (QR) code.

In accordance with process block 806, the second machine-readable component facilitates, in response to a capture of the client authentication credentials by a computing device, an automatic launching of a financial institution mobile application or a financial institution web application on the computing device.

In accordance with process block 806, the second machine-readable component facilitates, in response to a capture of the client authentication credentials by a computing device, an automatic population of client device authentication fields with the captured client authentication credentials on a user interface of the computing device.

In accordance with process block 806, the second machine-readable component facilitates, in response to a capture of the client authentication credentials by a computing device, automatic transmission of a command to a second computing device to accept the authentication credentials.

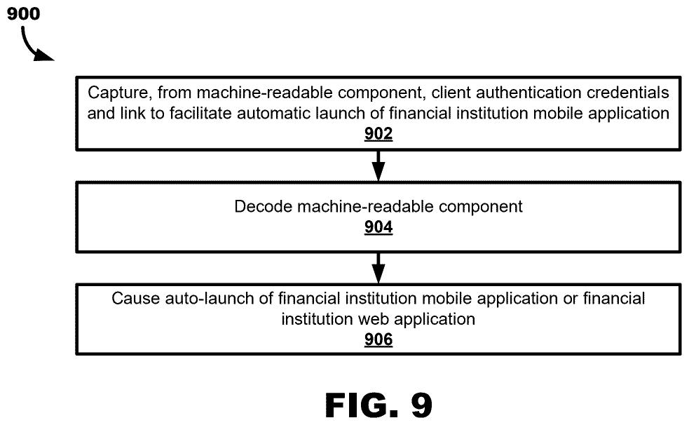

FIGS. 9 through 11 respectively set forth a computer-implemented method 900, 1000, and 1100. In one or more examples, the flowchart of the computer-implemented methods 900, 1000, and 1100 may be implemented by the one or more processors 110A, 110B of the mobile device 100A or personal computing device 100B as well the one or more processors 210 of the one or more financial institution servers 200. In particular, the computer-implemented methods 900, 1000, and 1100 may be implemented as one or more modules or engines in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the mobile device 100A, the personal computing device 100B, or the one or more financial institution servers 200 provides functionality described or illustrated herein. In particular, software executed by the one or more processors 110A, 1101B, or 210 is operable to perform one or more processing blocks of the computer-implemented methods 900, 1000, and 1100 set forth, described, and/or illustrated herein, or provides functionality set forth, described, and/or illustrated. The process blocks set forth, described, and/or illustrated in the computer-implemented method 800 may be performed or executed in any combination.

As illustrated in FIG. 9, illustrated process block 902 of computer-implemented method 900 includes capturing, by a computing device (e.g., mobile device 100A) from a machine-readable component (e.g., second machine-readable component 510) displayed on a transaction card (e.g., transaction card 500), client authentication credentials and a link to facilitate an automatic launch of a financial institution mobile application or a financial institution web application to facilitate client device access to and client management of one or more financial accounts maintained by a financial institution.

The computer-implemented method 900 may then proceed to illustrated process block 904, which includes decoding, by the computing device in response to capturing the client authentication credentials and the link, the machine-readable component.

In accordance with process block 904, the machine-readable component comprises a two-dimensional, machine-readable barcode.

In accordance with process block 904, the two-dimensional, machine-readable barcode comprises a quick response (QR) code.

The computer-implemented method 900 may then proceed to illustrated process block 906, which includes causing, by the computing device on a user interface (e.g., UI 131A) of the computing device in response to capturing the link, an automatic launch of the financial institution mobile application or the financial institution web application on the computing device.

In accordance with process block 906, causing the automatic launch of the financial institution mobile application or the financial institution web application comprises causing a visual display of a client device authentication dashboard associated with the financial institution mobile application.

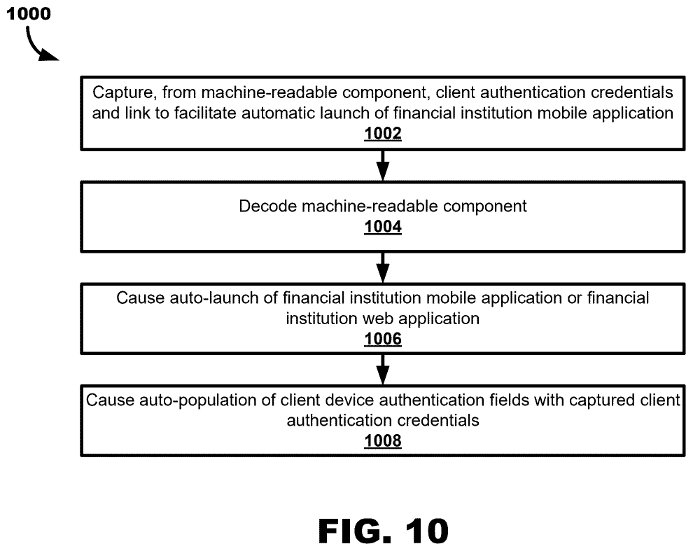

As illustrated in FIG. 10, illustrated process block 1002 of computer-implemented method 1000 includes capturing, by a computing device (e.g., mobile device 100A) from a machine-readable component (e.g., second machine-readable component 510) displayed on a transaction card (e.g., transaction card 500), client authentication credentials and a link to facilitate an automatic launch of a financial institution mobile application or a financial institution web application to facilitate client device access to and client management of one or more financial accounts maintained by a financial institution.

The computer-implemented method 1000 may then proceed to illustrated process block 1004, which includes decoding, by the computing device in response to capturing the client authentication credentials and the link, the machine-readable component.

In accordance with process block 1004, the machine-readable component comprises a two-dimensional, machine-readable barcode.

In accordance with process block 1004, the two-dimensional, machine-readable barcode comprises a quick response (QR) code.

The computer-implemented method 1000 may then proceed to illustrated process block 1006, which includes causing, by the computing device on a user interface (e.g., UI 131A) of the computing device in response to capturing the link, an automatic launch of the financial institution mobile application or the financial institution web application on the computing device.

In accordance with process block 1006, causing the automatic launch of the financial institution mobile application or the financial institution web application comprises causing a visual display of a client device authentication dashboard associated with the financial institution mobile application.

The computer-implemented method 1000 may then proceed to illustrated process block 1008, which includes causing, by the computing device in response to capturing the client authentication credentials, automatic population of client device authentication fields with the captured client authentication credentials.

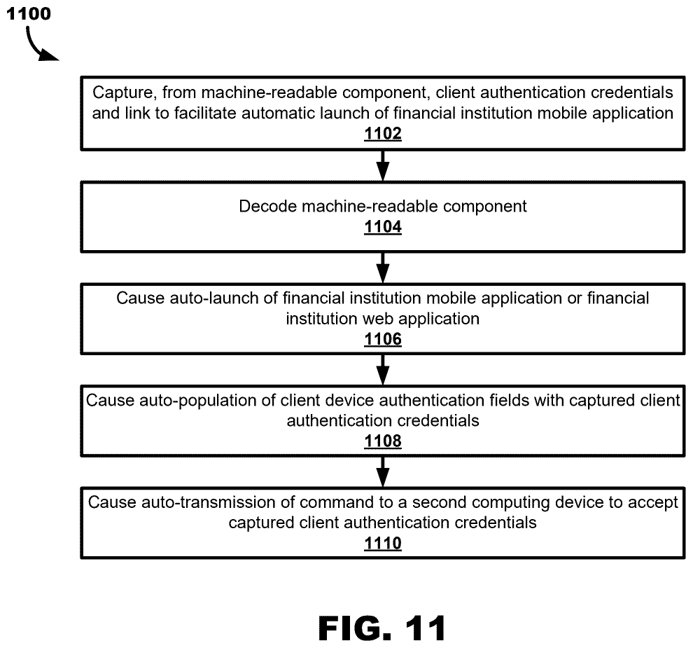

As illustrated in FIG. 11, illustrated process block 1102 of computer-implemented method 1100 includes capturing, by a computing device (e.g., mobile device 100A) from a machine-readable component (e.g., second machine-readable component 510) displayed on a transaction card (e.g., transaction card 500), client authentication credentials and a link to facilitate an automatic launch of a financial institution mobile application or a financial institution web application to facilitate client device access to and client management of one or more financial accounts maintained by a financial institution.

The computer-implemented method 1100 may then proceed to illustrated process block 1104, which includes decoding, by the computing device in response to capturing the client authentication credentials and the link, the machine-readable component.

In accordance with process block 1104, the machine-readable component comprises a two-dimensional, machine-readable barcode.

In accordance with process block 1104, the two-dimensional, machine-readable barcode comprises a quick response (QR) code.

The computer-implemented method 1100 may then proceed to illustrated process block 1106, which includes causing, by the computing device on a user interface (e.g., UI 131A) of the computing device in response to capturing the link, an automatic launch of the financial institution mobile application or the financial institution web application on the computing device.

In accordance with process block 1106, causing the automatic launch of the financial institution mobile application or the financial institution web application comprises causing a visual display of a client device authentication dashboard associated with the financial institution mobile application.

The computer-implemented method 1100 may then proceed to illustrated process block 1108, which includes causing, by the computing device in response to capturing the client authentication credentials, automatic population of client device authentication fields with the captured client authentication credentials.

The computer-implemented method 1100 may then proceed to illustrated process block 1110, which includes causing, by the computing device in response to the automatic population of the client device authentication fields, automatic transmission of a command to a second computing device to accept the authentication credentials.

In accordance with one or more embodiments set forth, described, and/or illustrated herein, the client device 100 and the one or more financial institution servers 200 could function in a fully virtualized environment. A virtual machine is where all hardware is virtual and the operation is run or executed over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software executing on hardware platform, and one or more virtual machines executing on hardware platform by way of virtualization software. Virtualization software is therefore logically interposed between the physical hardware of hardware platform and guest system software executing “in” virtual machine.

Memory of the hardware platform may store virtualization software and guest system software executing in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A transaction card, comprising:
a substrate that includes:
a first surface having a first machine-readable component displayed thereon to facilitate contactless financial transactions, and
a second surface, opposite the first surface, having a second machine-readable component displayed thereon and which contains client authentication credentials and a link to facilitate an automatic launch of a financial institution mobile application or a financial institution web application.

2. The transaction card of claim 1, wherein the substrate has an irregular polygonal shape that is asymmetric along at least one axis.

3. The transaction card of claim 1, wherein the first machine-readable component comprises a smart chip.

4. The transaction card of claim 1, wherein the second machine-readable component comprises a two-dimensional, machine-readable barcode.

5. The transaction card of claim 1, wherein the second machine-readable component facilitates, in response to a capture of the client authentication credentials by a computing device, an automatic launching of a financial institution mobile application or a financial institution web application on the computing device.

6. The transaction card of claim 1, wherein the second machine-readable component facilitates, in response to a capture of the client authentication credentials by a computing device, an automatic population of client device authentication fields with the captured client authentication credentials on a user interface of the computing device.

7. The transaction card of claim 1, wherein the second machine-readable component facilitates, in response to a capture of the client authentication credentials by a computing device, automatic transmission of a command to a second computing device to accept the authentication credentials.

8. A computer-implemented system, comprising:
one or more processors; and
a non-transitory memory coupled to the one or more processors, the non-transitory memory including a set of instructions, which when executed by the one or more processors, cause a computing device to:
capture, from a machine-readable component displayed on a transaction card, client authentication credentials and a link to facilitate an automatic launch of a financial institution mobile application or a financial institution web application; and
causing, on a user interface of the computing device in response to capturing the link, an automatic launch of a financial institution mobile application on the computing device.

9. The computer-implemented system of claim 8, wherein the machine-readable component comprises a two-dimensional, machine-readable barcode.

10. The computer-implemented system of claim 9, wherein the non-transitory memory including a set of instructions, which when executed by the one or more processors, cause the computing device to decode, in response to capturing the client authentication credentials and temporally before causing the automatic launch of the financial institution mobile application or the financial institution web application, the two-dimensional, machine-readable barcode.

11. The computer-implemented system of claim 8, wherein causing the automatic launch of the financial institution mobile application comprises causing a visual display of a client device authentication dashboard associated with the financial institution mobile application.

12. The computer-implemented system of claim 11, wherein the client device authentication dashboard includes a plurality of client device authentication fields.

13. The computer-implemented system of claim 12, wherein the non-transitory memory including a set of instructions, which when executed by the one or more processors, cause the computing device to cause, in response to capturing the client authentication credentials, automatic population of the client device authentication fields with the captured client authentication credentials.

14. The computer-implemented system of claim 13, wherein the non-transitory memory including a set of instructions, which when executed by the one or more processors, cause the computing device to cause, in response to the automatic population of the client device authentication fields, automatic transmission of a command to a second computing device to accept the authentication credentials.

15. A computer-implemented method, comprising:
capturing, by a computing device from a machine-readable component displayed on a transaction card, client authentication credentials and a link to facilitate an automatic launch of a financial institution mobile application or a financial institution web application; and
causing, by the computing device on a user interface of the computing device in response to capturing the link, an automatic launch of the financial institution mobile application or the financial institution web application on the computing device.

16. The computer-implemented method of claim 15, wherein the machine-readable component comprises a two-dimensional, machine-readable barcode.

17. The computer-implemented method of claim 16, further comprising decoding, by the computing device in response to capturing the client authentication credentials and temporally before causing the automatic launch of the financial institution mobile application or the financial institution web application and the link, the two-dimensional, machine-readable barcode.

18. The computer-implemented method of claim 15, wherein causing the automatic launch of the financial institution mobile application or the financial institution web application comprises causing a visual display of a client device authentication dashboard associated with the financial institution mobile application, the client device authentication dashboard including a plurality of client device authentication fields.

19. The computer-implemented method of claim 18, further comprising causing, by the computing device in response to capturing the client authentication credentials, automatic population of the client device authentication fields with the captured client authentication credentials.

20. The computer-implemented method of claim 19, further comprising causing, by the computing device in response to the automatic population of the client device authentication fields, automatic transmission of a command to a second computing device to accept the authentication credentials.
